(19) United States
(12) Patent Application Publication
(10) Pub. No.: US 2024/0170174 A1
(43) Pub. Date: May 23, 2024

(54) Waste Material Encapsulation Using Polymeric Materials

(71) Applicant: Battelle Memorial Institute, Richland, WA (US)

(72) Inventor: Josef MATYAS, Richland, WA (US)

(21) Appl. No.: 18/518,440

(22) Filed: Nov. 22, 2023

Related U.S. Application Data
(60) Provisional application No. 63/427,513, filed on Nov. 23, 2022.

(51) Int. Cl. G21F 9/30; B01J 20/02; B01J 20/10; B01J 20/28; B01J 20/30; B01J 20/32

(52) U.S. Cl. CPC G21F 9/307; B01J 20/0233; B01J 20/103; B01J 20/28047; B01J 20/28061; B01J 20/3085; B01J 20/3204; B01J 20/3234

(57) ABSTRACT

Implementations are described herein that include producing waste forms that include an amount of radioactive waste material encapsulated in an amount of polymeric material. The waste form can be produced by heating a mixture that includes the polymeric material and the radioactive waste material. The heated or molten mixture is then subject to a process that applies an amount of pressure to the heated mixture and produces the waste form.

### CLAIM OF PRIORITY

This patent application claims the benefit of priority to U.S. Provisional Patent application Ser. No. 63/427,513, filed Nov. 23, 2022, which is incorporated by reference herein in its entirety.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### FIELD OF THE INVENTION

One or more implementations relate to the capture of waste materials using one or more polymeric materials to produce waste forms for long-term storage of the waste materials.

### BACKGROUND

Many industrial processes produce waste materials. In some cases, industrial processes can produce waste that is hazardous to humans and the environment. For example, industrial processes can produce waste products that include at least one of solids, liquids, or gases that include biological waste products, biomedical waste products, chemical waste products, heavy metal waste products, radioactive waste products, or combinations thereof. Waste produced by industrial processes can be collected, treated, and disposed of according to a number of methods depending on the characteristics of the waste material and the level of potential harm posed to humans and/or the environment. The processes, techniques, and systems used for the treatment and disposal of industrial waste are implemented to minimize or eliminate the impact of the industrial waste on humans and the environment.

### BRIEF DESCRIPTION OF THE DRAWINGS

FIG. 1 illustrates a framework to capture and encapsulate waste material from a waste stream, in accordance with one or more examples.

FIG. 2 illustrates a process to encapsulate and store waste material that has been captured in a sorbent material, in accordance with one or more examples.

FIG. 3 illustrates a flow diagram of a process to capture and store waste material produced in conjunction with one or more industrial processes, in accordance with one or more examples.

FIG. 4 includes optical images of samples produced with spark plasma sintering, which were subjected to chemical durability testing.

FIG. 5 includes optical images of samples produced with a low-temperature encapsulation method were subjected to chemical durability testing.

FIG. 6 includes scanning electron microscopy (SEM) micrographs of samples consolidated with spark plasma sintering.

FIG. 7 includes SEM micrographs of samples consolidated with low-temperature encapsulation.

### DETAILED DESCRIPTION

The following description includes a preferred best mode of implementations of the present disclosure. It will be clear from this description of the disclosure that the disclosure is not limited to these illustrated implementations but that the disclosure also includes a variety of modifications and embodiments thereto. Therefore, the present description should be seen as illustrative and not limiting. While the disclosure is susceptible of various modifications and alternative constructions, it should be understood, that there is no intention to limit the disclosure to the specific form disclosed, but, on the contrary, the disclosure is to cover all modifications, alternative constructions, and equivalents falling within the spirit and scope of the disclosure.

In various examples, industrial processes can produce radioactive waste. For example, radioactive waste can be produced as a result of nuclear fission reactions including uranium and plutonium, such as ²³⁵U slow-neutron fission, that are used to generate power for municipalities and businesses. Some nuclear waste products can include radioisotopes of cesium, strontium, tin, selenium, zirconium, palladium, and iodine. Radioisotopes produced by nuclear fission reactions that have a relatively long half-life can be subjected to long-term storage. Examples of radioisotopes that are subject to long-term storage can include gamma radiation emitters and/or radioisotopes that can accumulate easily in the human body, such as the accumulation of iodine in the thyroid gland.

Radioactive iodine can be produced through the processing of spent nuclear fuel. In particular, ¹²⁹I and ¹³¹I can be released into aqueous phases and gas streams present in nuclear fuel treatment processes. In some cases, radioactive iodine can be found in dissolver off-gas, ventilation off-gas, nuclear cell off-gas, and melter off-gas. Radioactive iodine released from nuclear fission reactions is typically captured and immobilized for long-term storage due to the relatively long half-life of ¹²⁹I.

Various technologies have been developed to capture and store radioactive iodine released in relation to nuclear fission processes, such as nuclear fuel reprocessing, salt-fueled molten salt reactor operations, waste treatment, and unexpected releases of nuclear fission byproducts. For examples, iodine absorbers that include metal-exchanged porous sorbents, have been used to absorb radioactive iodine. Additionally, chalcogels, porous organic polymers, and metal-organic frameworks have been proposed for the capture of iodine generated during fission of nuclear fuels. These sorbents can capture iodine using chemisorption, physisorption, or a combination thereof. In some specific examples, existing techniques for capturing and storing radioactive iodine include metal-exchanged zeolite sorbents, Ag-loaded aerogels, Ag-loaded xerogels, and Sn-based chalcogel sorbents. In at least some cases, the gel-based sorbents can have a greater amount of iodine loading capacity than zeolites, possibly due to the higher specific surface areas of the gel-based sorbents, but more likely due to the higher metal content in the gels compared to zeolites. Two of the most technologically mature iodine sorbents developed to date are silver mordenite (AgZ) and silver functionalized silica aerogel (Ag⁰-aerogel). AgZ is considered a benchmark for iodine capture in the US. Ag⁰-aerogels are an alternative material and considered to replace AgZ because of its higher selectivity and sorption capacity for iodine and better stability in expected off-gas operating conditions (e.g., high humidity and NOx). Radioactive iodine sorbents can be used in scrubbing processes that can remove gaseous iodine from one or more waste streams. In at least some scenarios, sorbent beds can be used to capture iodine from nuclear processing waste streams.

The iodine sorbents are typically not a final storage form. The long-term storage forms for the iodine sorbents have relatively low porosity and are comprised of materials that prevent transport of the radioiodine isotopes through the environment. In some cases, iodine has been incorporated into glass structures formed from borosilicates, silver oxides, phosphates, lead, and/or non-oxide chalcogenides (e.g., S, Se, and/or Te). Additionally, captured iodine can be encapsulated in glass composite materials that include a crystalline component, such as a ceramic material, contained in a glass matrix. Glass ceramics can also be formed by combining an iodine-containing material with a glass binder. Further, cement waste forms can be used to encapsulate radioactive iodine captured by a number of sorbents. In a number of situations, iodine loaded AgZ can be converted to a final waste form through post-processing in a canister. These demonstrations have been performed using hot isostatic pressing (HIP) and hot uniaxial pressing (HUP) to create a consolidated AgZ in steel canisters. The iodine loaded Ag⁰-aerogel can be converted into final waste form using HIP or spark plasma sintering (SPS). These processes apply heat and pressure to collapse the aerogel structure, reducing its volume and eliminating void spaces to create a fully densified waste form containing radioactive iodine. HIP, HUP, and SPS are often performed at temperatures that are higher than the decomposition temperatures of iodine metal complexes included in the waste materials. This can lead to a release of radioactive iodine. In other scenarios, due to the temperatures used in relation to conventional techniques, the formation of waste forms that include radioactive iodine can be performed relatively quickly resulting in porous waste forms that are bulky and limit the amount of iodine storage that can take place for a given container.

The techniques, processes, methods, compounds, and compositions described herein are directed to the production of waste forms that include waste materials encapsulated in a polymeric material. The waste forms can be produced at temperatures that are less than the melting temperature of the polymeric material. In addition, the waste forms can be produced at temperatures above a glass transition temperature of the polymeric material. In situations where the waste forms are produced at temperatures below the glass transition temperature of the polymeric material, pressures used in the process to produce the waste form can be higher than the pressures when the waste form is produced at least at the glass transition temperature of the polymeric material.

The waste materials can include at least one of organic materials or ceramic materials. In one or more examples, the waste materials can include a waste compound and a sorbent material that has captured the waste compound. The waste compound can include one or more heavy metals. Additionally, the waste compound can include one or more radioisotopes. The polymeric material used to encapsulate the waste materials can have mechanical properties that have minimal or no degradation when exposed to the waste compound included in the waste material. Further, in situations where radioactive materials are being stored, the polymeric material can have properties that minimize or prevent the transmission of radioactive radiation through the waste form. It at least some examples, the polymer matrix can provide a stable and durable form that can prevent the release of radioactive material into the environment, while reducing the amount of radiation emitted into the environment. In one or more illustrative examples, the polymeric material can include monomer units having at least one aromatic ring. In one or more additional illustrative examples, the polymeric material can include monomer units comprising a cyanide moiety.

The implementations described herein can apply pressure during the process to produce the waste forms that results in the waste forms having a relatively low amount of porosity. The relatively low amount of porosity can be a result of the conditions under which the waste forms are produced and the characteristics of the polymeric materials used to encapsulate the waste materials. The low porosity can maximize storage of the waste material in a given container. In one or more examples, the amount of open porosity of the waste forms can be no greater than 1% by volume and a closed porosity of the waste form can be no greater than about 8% by volume. Additionally, performing the encapsulation process at relatively low temperatures minimizes the release of volatile waste compounds included in the waste materials being encapsulated.

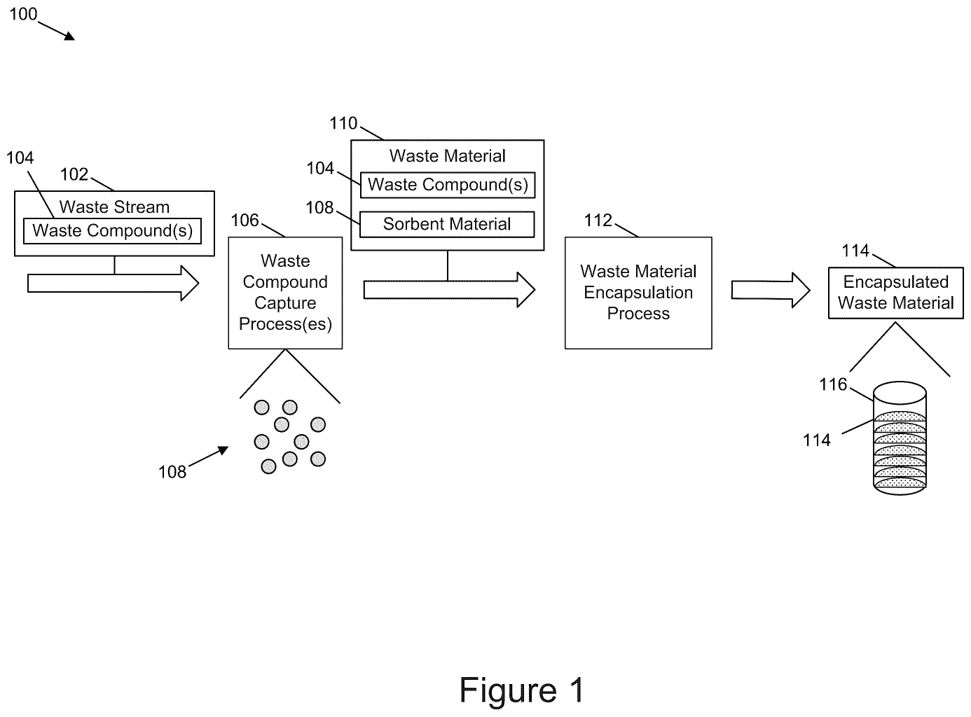

FIG. 1 illustrates a framework 100 to capture and encapsulate waste material from a waste stream, in accordance with one or more examples. The framework 100 can include a waste stream 102. The waste stream 102 can be produced by one or more industrial processes. The one or more industrial processes can include manufacturing processes, biomedical processes, nuclear reaction processes, chemical reaction processes, one or more combinations thereof, and the like. The waste stream 102 can be comprised of at least one of solid material, liquid material, or gaseous material.

The waste stream 102 can include one or more waste compounds 104. The one or more waste compounds 104 can be hazardous to at least one of human health or the environment. In various examples, the one or more waste compounds 104 can include one or more heavy metals (e.g., Pb, Cd, Hg, Cr, Ar), one or more plastics, one or more radioactive materials, one or more biological materials including harmful microorganisms (e.g., harmful bacteria, virus material, or harmful fungi), one or more toxic compounds, or one or more combinations thereof.

In one or more illustrative examples, the one or more waste compounds 104 can include radioactive iodine that is produced during the processing of spent fuel from nuclear fission reactions. For example, iodine isotopes can be produced as products of ²³⁵U slow-neutron fission, fast-neutron fission, and ²³⁹Pu fission. To illustrate, ¹²⁷I, ¹²⁹I, and ¹³¹I can be present in waste streams of nuclear fission reactions. In various examples, iodine isotopes can comprise less than 1% by weight of the fission products of a nuclear fuel. Iodine present in aqueous phases and gaseous phases of the nuclear fission waste streams can be released and be a component of off-gas streams of a number of processes involved in the reprocessing of used nuclear fuel, such as the fuel off-gas, the dissolver off-gas, the melter off-gas, and/or the ventilation off-gas. In various examples, the iodine waste stream can comprise gaseous radioactive iodine included in at least one of the following: fuel off-gas, the dissolver off-gas, the melter off-gas, or the ventilation off-gas. Iodine gas as used herein can correspond to I₂(g).

The framework 100 can also include one or more waste compound capture processes 106. The one or more waste compound capture processes 106 can include contacting the waste stream 102 with one or more compositions that have a capacity to capture the one or more waste compounds 104 present in the waste stream 102. In one or more examples, the one or more waste compound capture processes 106 can include one or more beds, one or more columns, or one or more filters that include sorbent material 108. The sorbent material 108 can have an affinity for the one or more waste compounds 104. For example, the sorbent material 108 can bind the one or more waste compounds 104 using at least one of covalent bonding, ionic bonding, polar covalent bonding, hydrogen bonding, metallic bonding, van der Waals bonding, peptide bonding, London dispersion force bonding, one or more combinations thereof, and so forth.

In various examples, the sorbent material 108 can have a structure that is conducive to the capture of the one or more waste compounds 104. To illustrate, the sorbent material 108 can have at least one of pores or cavities in which the one or more waste compounds 104 can be disposed. In at least some examples, the sorbent material 108 can be in the form of at least one of pellets, beads, particles, rods, tubes, fibers, or one or more combinations thereof. The sorbent material 108 can have dimensions that include at least one of length, height, width, or diameter. The sorbent material 108 can also be characterized by an aspect ratio and/or by a d₅₀ particle size, a d₁₀ particle size, a d₉₀ particle size, and so forth. In one or more illustrative examples, the sorbent material 108 can have dimensions of at least 400 micrometers, at least 500 micrometers, at least 600 micrometers, at least 700 micrometers, at least 800 micrometers, at least 900 micrometers, at least 1 millimeter (mm), at least 2 mm, or at least 5 mm. In one or more additional illustrative examples, the sorbent material 108 can have dimensions no greater than 30 mm, no greater than 20 mm, no greater than 10 mm, no greater than 8 mm, no greater than 6 mm, no greater than 5 mm, no greater than 4 mm, no greater than 3 mm, no greater than 2 mm, or no greater than 1 mm. In one or more further illustrative examples, the sorbent material 108 can have dimensions from 400 micrometers to 30 mm, from 800 micrometers to 20 mm, from 500 micrometers to 5 mm, from 500 micrometers to 2 mm, from 400 micrometers to 900 micrometers, from 10 mm to 20 mm, from 20 mm to 30 mm, or from 10 mm to 30 mm.

In scenarios where the one or more waste compounds 104 include radioactive iodine, the sorbent material 108 can have characteristics conducive to the capture radioactive iodine present in the waste stream 102. In one or more examples, sorbent material 108 used in the capture of radioactive iodine in the one or more waste compound capture processes 106 can include at least one of zeolites, aerogels, xerogels, chalcogels, porous organic polymers, metal-chalcogen-containing polymer composites, or metal-organic compounds. To illustrate, the sorbent material 108 can include Ag-zeolites, Ag-loaded aerogels, Ag-loaded xerogels, Sn-based chalcogels, or one or more combinations thereof. In one or more additional examples, the sorbent material 108 can include at least one of Ag-loaded alumina beads or Ag-loaded silica beads. In one or more further examples, the sorbent material 108 can include silver mordenite (AgZ) and/or silver functionalized silica aerogel (Ag⁰-aerogel). In at least some examples, metal included in the sorbent material 108 can react with iodine in the waste stream 102 to produce a metal-iodide. For example, in situations where the sorbent material 108 includes Ag, the waste material 110 can include AgI. In one or more additional illustrative examples, the sorbent material 108 can be produced according to techniques described in Matyáš J., G. E. Fryxell, B. J. Busche, K. Wallace, and L. S. Fifield, Functionalized silica aerogels: Advanced materials to capture and immobilize radioactive iodine, in Ceramic Materials for Energy Applications (Eds. H. Lin, Y. Katoh, K. M. Fox, I. Belharouak, S. Widjaja, and D. Singh), John Wiley & Sons, Inc., Hoboken, New Jersey, USA, doi: 10.1002/9781118095386.ch3, Ceramic Engineering and Science, 32 (9), 23-33, 2011. and Matyáš J., E. S. Ilton, and L. Kovarik, Silver-functionalized silica aerogel: towards an understanding of aging on iodine sorption performance, RSC Adv., 8, 31843-31852, 2018., which are incorporated by reference herein in their entirety.

In one or more examples, the waste material 110 can include at least about 5% by weight of the one or more waste compounds 104, at least about 10% by weight of the one or more waste compounds 104, at least about 15% by weight of the one or more waste compounds 104, at least about 20% by weight of the one or more waste compounds 104, at least about 25% by weight of the one or more waste compounds 104, at least about 30% by weight of the one or more waste compounds 104, at least about 35% by weight of the one or more waste compounds 104, at least about 40% by weight of the one or more waste compounds 104, at least about 45% by weight of the one or more waste compounds 104, or at least about 50% by weight of the one or more waste compounds 104. In one or more illustrative examples, the waste material 110 can include from about 5% by weight to about 60% by weight of the one or more waste compounds 104, from about 10% by weight to about 50% by weight of the one or more waste compounds 104, from about 20% by weight to about 40% by weight of the one or more waste compounds 104, from about 10% by weight to about 30% by weight of the one or more waste compounds 104, from about 30% by weight to about 50% by weight of the one or more waste compounds 104, from about 40% by weight to about 60% by weight of the one or more waste compounds 104, or from about 40% by weight to about 50% by weight of the one or more waste compounds 104.

The framework 100 can also include a waste material encapsulation process 112. The waste material encapsulation process 112 can include encapsulating the waste material 110 in a medium that minimizes or prevents release of the one or more waste compounds 104 into an environment. In one or more examples, the waste material encapsulation process 112 can include encapsulating the waste material 110 in one or more polymeric materials. In at least some examples, encapsulating, as used herein, can include enclosing or covering at least a substantial portion of one material with another material. For example, encapsulation of the waste material 110 can include enclosing or covering instances of the waste material 110, such as fragments, particles, and the like, with an encapsulation material. In various examples, at least about 80% of individual instances of the waste material 110, such as individual particles or individual fragments of the waste material 110, can be enclosed in or covered by one or more polymeric material, at least about 85% of individual instances of the waste material 110 can be enclosed in or covered by one or more polymeric materials, at least about 90% of individual instances of the waste material 110 can be enclosed in or covered by one or more polymeric materials, at least about 95% of individual instances of the waste material 110 can be enclosed in or covered by one or more polymeric materials, at least about 99% of individual instances of the waste material 110 can be enclosed in or covered by one or more polymeric materials, substantially all of the individual instances of the waste material 110 can be enclosed in or covered by one or more polymeric materials, or all of the individual instances of the waste material 110 can be enclosed in or covered by one or more polymeric materials. In scenarios where the waste material 110 includes radioactive iodine, metal iodides present in the waste material 110 can be encapsulated in the one or more polymeric materials.

The waste material encapsulation process 112 can be performed at temperatures below melting and decomposition temperatures of the one or more waste compounds 104 and/or melting and decomposition temperatures of complexes formed between the one or more waste compounds 104 and the sorbent material 108. Additionally, the waste material encapsulation process 112 can be performed below melting and decomposition temperatures of the one or more polymeric materials used to encapsulate the waste material 110. In one or more illustrative scenarios where the one or more waste compounds 104 include radioactive iodine, the sorbent material 108 includes Ag, and the waste material 110 includes AgI, the waste material encapsulation process 112 can be performed at temperatures less than the decomposition temperature of AgI of about 558° C. In one or more illustrative scenarios where polyacrylonitrile is used in the waste material encapsulation process 112 to encapsulate the waste material 110, the waste material encapsulation process 112 can be performed at temperatures no greater than the melting temperature of polyacrylonitrile of about 300° C. to about 317° C. In still other examples, the waste material encapsulation process 112 can be performed using a range of pressures. In at least some scenarios, the waste material encapsulation process 112 can be performed at pressures from no greater than 10 megapascals (MPa) to pressures no greater than 700 MPa. In one or more additional examples, the waste material encapsulation process 112 can include at least one of a uniaxial pressing process, an extrusion process, or an injection molding process.

The waste material encapsulation process 112 can produce encapsulated waste material 114. In one or more examples, the encapsulated waste material 114 can be stored in a container 116. In at least some examples, the encapsulated waste material 114 can have a greater density than the waste material 110. In addition, an amount of open porosity of the encapsulated waste material 114 can be less than an amount of open porosity of the waste material 110. To illustrate, the encapsulated waste material 114 can have an open porosity from about 0.2% by volume of the encapsulated waste material 114 to about 1.0% by volume of the encapsulated waste material 114.

In one or more examples, the encapsulated waste material 114 can be formed into a shape by the waste material encapsulation process 112. For example, the waste material encapsulation process 112 can produce encapsulated waste material 114 in the shape of pellets, discs, cylinders, and the like, for storage in a container, such as the container 116. In various examples, the shape of the encapsulated waste material 114 can be based on a shape of a die or mold used in the waste material encapsulation process 112. In one or more illustrative examples, the encapsulated waste material 114 can have diameters from about 5 mm to about 50 mm and heights from about 1 mm to about 10 mm.

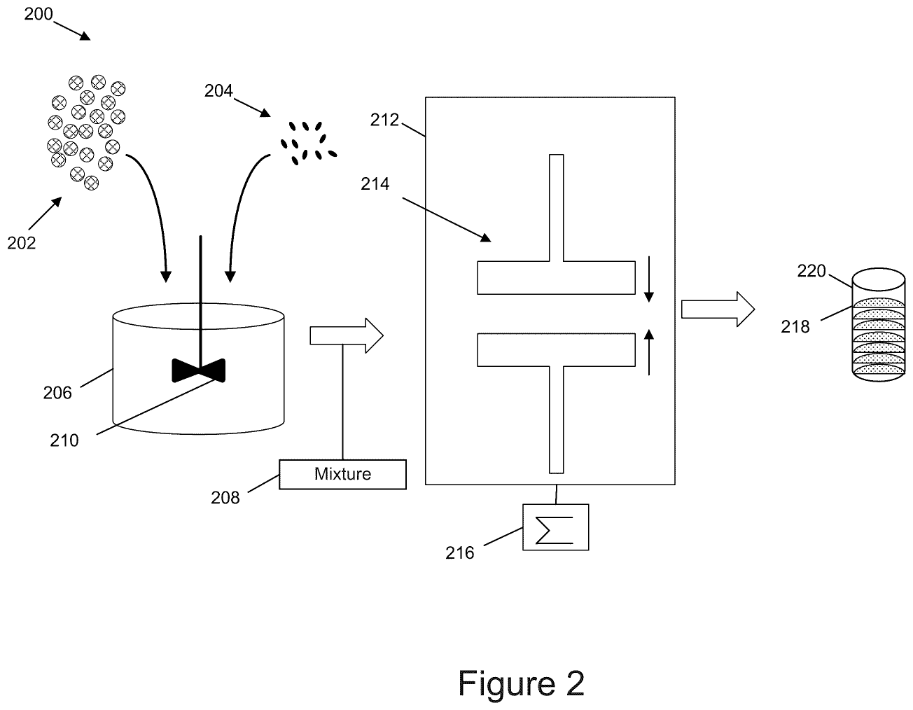

FIG. 2 illustrates a process 200 to encapsulate and store waste material 202 that has been captured in a sorbent material, in accordance with one or more examples. The waste material 202 can be encapsulated in one or more polymeric materials 204. In one or more examples, the waste material 202 can include the waste material 110 described with respect to FIG. 1. In various examples, the waste material 202 can include one or more waste compounds and one or more sorbent materials that bind and/or capture the one or more waste compounds. In at least some examples, the waste material 202 can include a complex between the one or more waste compounds and the one or more sorbent materials. In one or more illustrative examples, the waste material 202 can include radioactive iodine. In these scenarios, the waste material 202 can include at least one of one or more metals or silica to bind the radioactive iodine. In one or more additional illustrative examples, the waste material 202 can include a metal iodide. For example, the waste material 202 can include at least one of AgI, SnI₄, SnI₂, CuI₂, or BiI₃. In one or more further examples, the waste material 202 can include a metal-silica-iodine complex. In various illustrative examples, the waste material 202 can include silver mordenite (AgZ) and/or silver functionalized silica aerogel (Ag⁰-aerogel) loaded with a radioactive isotope of iodine.

In one or more examples, the waste material 202 can have dimensions of at least 400 micrometers, at least 500 micrometers, at least 600 micrometers, at least 700 micrometers, at least 800 micrometers, at least 900 micrometers, at least 1 mm, at least 2 mm, or at least 3 mm. In one or more additional illustrative examples, the waste material 202 can have dimensions no greater than 30 mm, no greater than 20 mm, no greater than 10 mm, no greater than 8 mm, no greater than 6 mm, no greater than 5 mm, no greater than 4 mm, no greater than 3 mm, no greater than 2 mm, or no greater than 1 mm. In one or more further illustrative examples, the waste material 202 can have dimensions from 500 micrometers to 10 mm, from 1 mm to 10 mm, from 5 mm to 15 mm, from 10 mm to 20 mm, from 15 mm to 25 mm, from 800 micrometers to 5 mm, from 5 mm to 10 mm, from 500 micrometers to 2 mm, or from 800 micrometers to 4 mm.

In various examples, the waste material 202 can be subjected to a grinding process to reduce dimensions of the waste material 202. In these scenarios, the waste material 202 can have dimensions no greater than 100 micrometers, no greater than 90 micrometers, no greater than 80 micrometers, no greater than 70 micrometers, no greater than 60 micrometers, no greater than 50 micrometers, no greater than 40 micrometers, or no greater than 30 micrometers. To illustrate, when subjected to a grinding process, the waste material 202 can have dimensions from about 10 micrometers to about 100 micrometers, from about 20 micrometers to about 80 micrometers, from about 30 micrometers to about 70 micrometers, from about 40 micrometers to about 60 micrometers, from about 10 micrometers to about 50 micrometers, or from about 40 micrometers to about 90 micrometers.

In one or more examples, the one or more polymeric materials 204 can have a form of pellets, beads, particles, rods, tubes, fibers, granules, or one or more combinations thereof. In various examples, the one or more polymeric materials 204 can have a mean particle size from about 10 micrometers to about 400 micrometers, from about 50 micrometers to about 300 micrometers, from about 100 micrometers to about 200 micrometers, from about 30 micrometers to about 100 micrometers, from about 20 micrometers to about 60 micrometers, from about 50 micrometers to about 100 micrometers, from about 80 micrometers to about 150 micrometers, from about 120 micrometers to about 200 micrometers, or from about 180 micrometers to about 240 micrometers.

In at least some examples, the one or more polymeric materials 204 can have a melting temperature or decomposition temperature of at least about 200° C., at least about 220° C., at least about 250° C., at least about 280° C., at least about 300° C., at least about 320° C., at least about 350° C., at least about 380° C., or at least about 400° C. In one or more illustrative examples, the one or more polymeric materials 204 can have a melting temperature or decomposition temperature from about 200° C. to about 450° C., from about 250° C. to about 350° C., from about 280° C. to about 320° C., from about 200° C. to about 250° C., from about 300° C. to about 350° C., or from about 320° C. to about 400° C. In one or more further examples, the one or more polymeric materials 204 can have a glass transition temperature from about 60° C. to about 300° C., from about 80° C. to about 150° C., from about 100° C. to about 200° C., from about 80° C. to about 120° C., or from about 120° C. to about 200° C.

In still other examples, the one or more polymeric materials 204 can have a weight-average molecular weight of at least about 15,000 g/mol, at least about 30,000 g/mol, at least about 45,000 g/mol, at least about 60,000 g/mol, at least about 75,000 g/mol, at least about 90,000 g/mol, at least about 100,000 g/mol, at least about 120,000 g/mol, at least about 140,000 g/mol, at least about 160,000 g/mol, at least about 180,000 g/mol, or at least about 200,000 g/mol. In one or more additional illustrative examples, the one or more polymeric materials 204 can have a weight-average molecular weight from about 15,000 g/mol to about 250,000 g/mol, from about 30,000 g/mol to about 200,000 g/mol, from about 50,000 g/mol to about 100,000 g/mol, from about 20,000 g/mol to about 50,000 g/mol, from about 75,000 to about 120,000 g/mol, from about 100,000 g/mol to about 150,000 g/mol, from about 120,000 g/mol to about 160,000 g/mol, or from about 140,000 g/mol to about 200,000 g/mol.

In one or more further examples, the one or more polymeric materials 204 can have an amorphous density of at least about 0.6 g/cm³, at least about 0.8 g/cm³, at least about 1.0 g/cm³, at least about 1.2 g/cm³, at least about 1.4 g/cm³, at least about 1.6 g/cm³, at least about 1.8 g/cm³, at least about 2.0 g/cm³, at least about 2.2 g/cm³, at least about 2.4 g/cm³, at least about 2.6 g/cm³, at least about 2.8 g/cm³, or at least about 3.0 g/cm³. In one or more illustrative examples, the one or more polymeric materials 204 can have an amorphous density from about 0.6 g/cm³ to about 3.5 g/cm³, from about 0.8 g/cm³ to about 3.0 g/cm³, from about 1.2 g/cm³ to about 2.0 g/cm³, from about 1.6 g/cm³ to about 2.4 g/cm³, or from about 2.2 g/cm³. to about 3.0 g/cm³.

In various examples, the one or more polymeric materials 204 can include one or more thermosets. In addition, the one or more polymeric materials 204 can include one or more thermoplastics. Further, the one or more polymeric materials 204 can include one or more elastomers. In at least some examples, the one or more polymeric materials 204 can include at least one of one or more thermosets, one or more thermoplastics, or one or more elastomers.

In at least some examples, the one or more polymeric materials 204 can include one or more aliphatic polymers. In still other examples, the one or more polymeric materials 204 can include one or more aromatic polymers. The one or more polymeric materials 204 can also include one or more fluoropolymers. In one or more additional examples, the one or more polymeric materials 204 can include one or more polyacrylics. In one or more further examples, the one or more polymeric materials 204 can include one or more polyamides. In various examples, the one or more polymeric materials 204 can include one or more aromatic or semi-aromatic polyamides.

In at least some examples, the one or more polymeric materials 204 can include one or more polyimides. In one or more scenarios, the one or more polymeric materials 204 can include one or more aromatic or semi-aromatic polyimides. In various additional examples, the one or more polymeric materials 204 can include one or more polyesters. In one or more illustrative examples, the one or more polymeric materials 204 can include at least one of one or more aliphatic polymers, one or more aromatic polymers, one or more fluoropolymers, one or more polyacrylics, one or more polyamides, one or more polyimides, or one or more polyesters.

In one or more examples, the one or more polymeric materials 204 can have characteristics that prevent or minimize the breakdown of the structure one or more polymeric materials 204 and/or prevent or minimize the loss of mechanical properties of the one or more polymeric materials 204 in the presence of the one or more waste compounds included in the waste material 202. In various examples, the one or more polymeric materials 204 can have characteristics that prevent or minimize the breakdown of the structure one or more polymeric materials 204 and/or prevent or minimize the loss of mechanical properties of the one or more polymeric materials 204 in the presence of radioactive compounds. For example, the one or more polymeric materials 204 can have characteristics that prevent or minimize the breakdown of the structure one or more polymeric materials 204 and/or prevent or minimize the loss of mechanical properties of the one or more polymeric materials 204 in the presence of at least one of gamma radiation or alpha radiation. In still other examples, the one or more polymeric materials 204 can have characteristics that prevent or minimize the breakdown of the structure one or more polymeric materials 204 and/or prevent or minimize the loss of mechanical properties of the one or more polymeric materials 204 in the presence of one or more radioactive isotopes of iodine.

In one or more illustrative examples, the one or more polymeric materials 204 can include polyethylene terephthalate or polyethylene terephthalate glycol. In one or more additional illustrative examples, the one or more polymeric materials 204 can include polyether ether ketone. In one or more further illustrative examples, the one or more polymeric materials 204 can include a polycarbonate. In still other illustrative examples, the one or more polymeric materials 204 can include polydiallyl phthalate. Additionally, the one or more polymeric materials 204 can include polyacrylonitrile. Further, the one or more polymeric materials 204 can include at least one of polyethylene terephthalate, polyethylene terephthalate glycol, polyether ether ketone, polysulfone, polyether sulfonate, polyethylenimine a polycarbonate, polydiallyl phthalate, or polyacrylonitrile.

The waste material 202 and the one or more polymeric materials 204 can be added to a container 206 to produce a mixture 208. For example, the waste material 202 and the one or more polymeric materials 204 can be mixed in the container 206. In various examples, the waste material 202 and the one or more polymeric materials 204 can be mixed in the container 206 using one or more mixing devices 210. In at least some examples, the one or more mixing devices 210 can include one or more mechanical mixing devices or one or more sonic mixing devices. In one or more illustrative examples, the mixing device can include a mechanical stir bar, a paddle, or a sonicator. In still other examples, the one or more mixing devices 210 can comprise beads or other particles and the waste material 202 and the one or more polymeric materials 204 can be mixed using the beads and by rotating, turning, or otherwise moving, the container 206. In one or more illustrative examples, the waste material 202 and the one or more polymeric materials 204 can be mixed in the container 206 until the mixture 208 is at least a substantially homogeneous combination of the waste material 202 and the one or more polymeric materials 204.

In one or more additional illustrative examples, the container 206 can include or be included in a mixer. The mixer can be included in or coupled to an extruder system. In these situations, the waste material 202 and the one or more polymeric materials 204 can be heated above a glass transition temperature of the one or more polymeric materials 204 to homogenously blend powders of the waste material 202 and molten forms of the one or more polymeric materials 204. The homogenous mixture can then be injection molded or compression molded according to a number of specified shapes and sizes. In various examples, the homogenous mixture can be molded to regular shapes, irregular shapes, circular shapes, polygonal shapes, rectangular shapes, cubic shapes, elliptical shapes, one or more combinations thereof, and the like.

In one or more examples, the mixture 208 can include at least about 20% by volume of the one or more polymeric materials 204, at least about 30% by volume of the one or more polymeric materials, at least about 40% by volume of the one or more polymeric materials 204, at least about 50% by volume of the one or more polymeric materials 204, at least about 60% by volume of the one or more polymeric materials 204, at least about 65% by volume of the one or more polymeric materials 204, at least about 70% by volume of the one or more polymeric materials 204, at least about 75% by volume of the one or more polymeric materials 204, or at least about 80% by volume of the one or more polymeric materials 204, at least about 85% by volume of the one or more polymeric materials 204, at least about 90% by volume of the one or more polymeric materials 204, or at least about 95% by volume of the one or more polymeric materials 204. In one or more illustrative examples, the mixture 208 can include from about 20% by volume to about 98% by volume of the one or more polymeric materials 204, from about 20% by volume to about 50% by volume of the one or more polymeric materials 204, from about 30% by volume to about 60% by volume of the one or more polymeric materials 204, from about 40% by volume to about 70% by volume of the one or more polymeric materials 204, from about 50% by volume to about 80% by volume of the one or more polymeric materials 204, from about 60% by volume to about 80% by volume of the one or more polymeric materials 204, or from about 70% by volume to about 80% by volume of the one or more polymeric materials 204.

In one or more additional examples, the mixture 208 can include at least about 2% by volume of the waste material 202, at least about 5% by volume of the one waste material 202, at least about 10% by volume of the waste material 202, at least about 20% by volume of the waste material 202, at least about 30% by volume of the waste material 202, at least about 40% by volume of the waste material 202, at least about 50% by volume of the waste material 202, at least about 60% by volume of the waste material 202, at least about 70% by volume of the waste material 202, or at least about 80% by volume of the waste material 202. In one or more illustrative examples, the mixture 208 can include from about 20% by volume to about 98% by volume of the waste material 202, from about 30% by volume to about 60% by volume of the waste material 202, from about 40% by volume to about 70% by volume of the waste material 202, from about 20% by volume to about 40% by volume of the waste material 202, from about 30% by volume to about 50% by volume of the waste material 202, or from about 20% by volume to about 30% by volume of the waste material 202.

In one or more further illustrative examples, a ratio of the amount of the one or more polymeric materials 204 to the amount of the waste material 202 by volume in the mixture 208 can be at least about 1:1, at least about 1.2:1, at least about 1.5:1, at least about 1.8:1, at least about 2:1, at least about 2.2:1, at least about 2.5:1, at least about 2.8:1, at least about 3:1, at least about 3.2:1, or at least about 3.5:1. The ratio of the amount of the one or more polymeric materials 204 to the amount of the waste material 202 by volume in the mixture 208 can be from about 1:1 to about 4:1, from about 1.5:1 to about 3.5:1, from about 2:1 to about 3:1, or from about 2.5:1 to about 3.5:1.

In at least some illustrative examples, the mixture 208 can include from about 20% by volume to about 30% by volume of the waste material 202 and from about 70% by volume to about 80% by volume of the one or more polymeric materials 204. In various examples, the amount of the one or more polymeric materials 204 included in the mixture 208 can be sufficient to encapsulate the waste material 202. In at least some examples when the amount of the waste material 202 is from about 40% by volume to about 50% by volume of the mixture 208 and the amount of the one or more polymeric materials 204 is from about 50% by volume to about 60% by volume of the mixture 208, the waste material 202 can be subject to a grinding process to reduce the size of the particles of the waste material 202 such that the particles of the waste material 202 can be encapsulated by the one or more polymeric materials 204.

The process 200 can include providing the mixture 208 to an apparatus 212. The apparatus 212 can include a pressure inducing device 214. The pressure inducing device 214 can operate to apply pressure to the mixture 208. In at least some examples, the container 206 can be included in the apparatus 212 and the mixture 208 can be produced inside the apparatus 212. In one or additional examples, the container 206 can be external with respect to the apparatus 212. In one or more examples, the pressure inducing device 214 can comprise or be included in a die that is part of the apparatus 212. In various examples, the pressure inducing device 214 can include one or more components that move in a single or all directions to apply uniaxial or isostatic pressure to the mixture 208. The pressure inducing device 214 can also include one or more components that move towards one another to apply pressure to the mixture 208. The apparatus 212 can also include a heating device 216. The heating device 216 can operate to increase the temperature within the apparatus 212 in order to encapsulate the waste material 202 using the one or more polymeric materials 204. In various illustrative examples, the apparatus 212 can include an injection molding apparatus or a compression molding apparatus.

In various examples, the apparatus 212 can operate to apply at least one of pressure or heat to the mixture 208 to produce a waste form 218. In one or more examples, the apparatus 212 can function to heat the mixture 208 and then apply amount of pressure to the heated mixture to form the waste form 218. In one or more additional examples, the mixture 208 can be subjected to a pre-pressing operation at temperatures from about 15° C. to about 35° C. or from about 20° C. to about 30° C. before the mixture 208 is heated. In various examples, the pre-pressing operation can be performed at pressures from about 10 MPa to about 100 MPa or from about 20 MPa to about 50 MPa. In one or more illustrative examples, the waste form 218 can include encapsulated waste material 114 described with respect to FIG. 1. In at least some examples, the apparatus 212 can operate to heat at least one of the waste material 202 or the one or more polymeric materials 204 to temperatures between at least a glass transition temperature of the one or more polymeric materials 202 and no greater than a melting temperature or decomposition temperature of the one or more polymeric materials to blend the components of the mixture 208 and to then process the mixture 208 using at least one of compression molding or injection molding.

In various examples, the apparatus 212 can produce the waste form 218 from the waste material 202 and the one or more polymeric materials 204 at temperatures that are less than the melting or decomposition temperature of one or more waste compounds included in the waste material 202. In one or more illustrative examples, waste material 202 can include an iodine-loaded sorbent that comprises at least one of AgI, CuI, BiOI, BiI₃, SnI₄, or SnI₂. In these scenarios, a melting or decomposition temperature of AgI can be about 558° C., a melting or decomposition temperature of CuI can be about 606° C., a melting or decomposition temperature of SnI₄ can be about 143° C., a melting or decomposition temperature of SnI₂ can be about 320° C., a melting or decomposition temperature of BiOI can be about 308° C., and a melting or decomposition temperature of BiI₃ can be about 408.6° C. By producing the waste form 218 at temperatures that are lower than the decomposition temperatures or melting temperatures of one or more components of the waste material 202 and that are lower than conventional processes, the process 200 can prevent or minimize the release of one or more waste compounds included in the waste material 202.

In one or more additional illustrative examples, the apparatus 212 can produce the waste form 218 from waste material 202 and the one or more polymeric materials 204 at temperatures that are less than a decomposition temperature of the one or more polymeric materials 204 or greater than a glass transition temperature of the one or more polymeric materials 204. To illustrate, the one or more polymeric materials 204 can include polyacrylonitrile that has a decomposition temperature or melting temperature of about 317° C. and a glass transition temperature of about 95° C. In one or more further illustrative examples, the one or more polymeric materials 204 can include polyethylene terephthalate that has a decomposition temperature or melting temperature from about 245° C. to about 265° C. and a glass transition temperature from about 67° C. to about 81° C. In various examples, the one or more polymeric materials 204 can include polyethylene terephthalate glycol that has a decomposition temperature or melting temperature of about 260° C. and a glass transition temperature of about 85° C. In at least some examples, the one or more polymeric materials 204 can include polyether ether ketone that has a decomposition temperature or melting temperature of about 343° C. and a glass transition temperature of about 143° C. In still other examples, the one or more polymeric materials 204 can include polycarbonate that has a decomposition temperature or melting temperature of about 297° C. and a glass transition temperature of about 147° C. In still other examples, the one or more polymeric materials 204 can include polydiallyl phthalate that has a decomposition temperature or melting temperature of about 80° C. to about 110° C.

In one or more examples, the apparatus 212 can produce the waste form 218 from the mixture 208 including the waste material 202 and the one or more polymeric materials 204 by implementing the heating device 216 to expose the mixture 208 to temperatures of no greater than about 600° C., no greater than about 550° C., no greater than about 500° C., no greater than about 450° C., no greater than about 400° C., no greater than about 380° C., no greater than about 360° C., no greater than about 340° C., no greater than about 320° C., no greater than about 300° C., no greater than about 290° C., no greater than about 280° C., no greater than about 270° C., no greater than about 260° C., no greater than about 250° C., no greater than about 240° C., no greater than about 230° C., no greater than about 220° C., no greater than about 210° C., no greater than about 200° C., no greater than about 190° C., no greater than about 180° C., no greater than about 170° C., no greater than about 160° C., no greater than about 150° C., no greater than about 140° C., no greater than about 130° C., no greater than about 120° C., no greater than about 110° C., no greater than about 100° C., no greater than about 90° C., or no greater than about 80° C. In one or more additional examples, the apparatus 212 can produce the waste form 218 from the mixture 208 including the waste material 202 and the one or more polymeric materials 204 at temperatures from 80° C. to 600° C., from 200° C. to 500° C., from 300° C. to 400° C., from 100° C. to 200° C., from 200° C. to 300° C., from 400° C. to 500° C., from 90° C. to 140° C., from 120° C. to 180° C., from 150° C. to 200° C., from 190° C. to 240° C., from 220° C. to 280° C., from 250° C. to 300° C., from 280° C. to 330° C., from 300° C. to 350° C., from 320° C. to 380° C., from 390° C. to 430° C., from 400° C. to 450° C., or from 450° C. to 500° C.

In one or more further examples, the apparatus 212 can produce the waste form 218 from the mixture 208 including the waste material 202 and the one or more polymeric materials 204 by compressing the mixture 208 using the pressure inducing device 214. For example, the pressure inducing device 214 can be used to compress the mixture 208 to produce the waste form 218 at pressures from about 1 MPa to about 700 MPa, from about 20 MPa to about 600 MPa, from about 50 MPa to about 500 MPa, from about 100 MPa to about 400 MPa, from about 1 MPa to about 100 MPa, from about 10 MPa to about 50 MPa, from about 20 MPa to about 80 MPa, from about 100 MPa to about 200 MPa, from about 200 MPa to about 400 MPa, from about 300 MPa to about 500 MPa, from about 400 MPa to about 600 MPa, or from 500 MPa to about 700 MPa. In one or more examples, pressure can be applied to the mixture 208 by the pressure inducing device 214 for a period of time comprising from 0.3 minutes to 30 minutes, from 0.5 minutes to 25 minutes, from 1 minute to 20 minutes, from 5 minutes to 15 minutes, from 1 minutes to 20 minutes, from 5 minutes to 15 minutes, from 10 minutes to 20 minutes, from 15 minutes to 30 minutes, or from 20 minutes to 30 minutes. In various additional illustrative examples, the apparatus 212 can produce the waste form 218 from the mixture 208 without compression of the mixture 208. To illustrate, the apparatus 212 can produce the waste form 218 from the mixture 208 without applying additional pressure when the one or more polymeric materials 204 and/or the mixture 208 are heated to temperatures of at least the glass transition temperature of the one or more polymeric materials 204.

In still other examples, the apparatus 212 can produce the waste form 218 from the mixture 208 including the waste material 202 and the one or more polymeric materials 204 in a container that includes air present in an environment in which the apparatus 212 is located. Additionally, the apparatus 212 can produce the waste form 218 from the mixture 208 in a container that includes other inert gases, such as argon gas (Ar₂(g)), nitrogen gas (N₂(g)), helium gas (He(g)), and the like.

In various examples, the waste form 218 can include an amount of the waste material 202 and an amount of the one or more polymeric materials 204. In at least some examples, the waste form 218 can have a first phase comprised of one or more components of the waste material 202 and a second phase comprised of the one or more polymeric materials 204. For example, the encapsulated waste material can include a first phase having one or more waste compounds and sorbent material and second phase comprising the one or more polymeric materials 204.

The amount of the waste material 202 and the amount of the one or more polymeric materials 204 present in the waste form 218 can correspond to the amount of the waste material 202 and the amount of the one or more polymeric materials 204 present in the mixture 208. To illustrate, the waste form 218 can include from about 20% by volume to about 98% by volume of the one or more polymeric materials 204, from about 30% by volume to about 90% by volume of the one or more polymeric materials 204, from about 40% to about 60% by volume of the one or more polymeric materials, from about 50% by volume to about 70% by volume of the one or more polymeric materials 204, or from about 60% by volume to about 80% by volume of the one or more polymeric materials 204 and from about 2% by volume to about 80% by volume of the waste material 202, from about 5% by volume to about 70% by volume of the waste material 202, from about 10% by volume to about 50% by volume of the waste material 202, from about 20% by volume to about 40% by volume of the waste material, or from about 20% by volume to about 30% by volume of the waste material 202. Additionally, the ratio of the amount of the one or more polymeric materials 204 to the amount of the waste material 202 by volume in the waste form 218 can be from about 1:1 to about 4:1, from about 1.5:1 to about 3.5:1, from about 2:1 to about 3:1, from about 2.5:1 to about 3.5:1, from about 1:1 to about 9:1, from about 2:1 to about 8:1, or from about 3:1 to about 6:1.

In various examples, the waste form 218 can have a density of at least 0.5 g/cm³, at least 0.7 g/cm³, at least 0.9 g/cm³, at least 1.1 g/cm³, at least 1.3 g/cm³, at least 1.5 g/cm³, at least 1.7 g/cm³, at least 1.9 g/cm³, at least 2.2 g/cm³, at least 2.5 g/cm³, at least 2.8 g/cm³, at least about 3.0 g/cm³, at least about 3.5 g/cm³, or at least 4.0 g/cm³. In at least some examples, the waste form 218 can have a density from about 0.5 g/cm³ to about 4.0 g/cm³, from about 0.8 g/cm³ to about 3.0 g/cm³, from about 1 g/cm³ to about 2 g/cm³, from about 1.5 g/cm³ to about 2.5 g/cm³, or from about 1.2 g/cm³ to about 1.8 g/cm³. In one or more examples, the waste form 218 can have a greater density than a density of the waste material 202. In this way, the waste form 218 can be densified in relation to the waste material 202.

In still other examples, the waste form 218 can have an open porosity of at least about 0.1%, at least about 0.2%, at least about 0.3%, at least about 0.4%, at least about 0.5%, at least about 0.6%, at least about 0.7%, or at least about 0.8%. In one or more illustrative examples, the waste form 218 can have an open porosity from about 0.1% to about 1.0%, from about 0.2% to about 0.8%, from about 0.3% to about 0.7%, or from about 0.4% to about 0.6%. In various examples, an open porosity of the waste form 218 can be less than an open porosity of the waste material 202. In various additional examples, the waste form 218 can have a closed porosity from about 0.1% by volume to about 8% by volume, from about 1% by volume to about 6% by volume, from about 2% by volume to about 5% by volume, from about 3% by volume to about 6% by volume, or from about 1% by volume to about 3% by volume.

In one or more additional examples, the waste form 218 can include at least about 0.5% by mass of one or more waste compounds included in the waste material 202, at least about 2% by mass of one or more waste compounds included in the waste material 202, at least about 5% by mass of one or more waste compounds included in the waste material 202, at least about 10% by mass of one or more waste compounds included in the waste material 202, at least about 20% by mass of one or more waste compounds included in the waste material 202, at least about 30% by mass of one or more waste compounds included in the waste material 202, at least about 40% by mass of one or more waste compounds included in the waste material 202, at least about 50% by mass of one or more waste compounds included in the waste material 202, at least about 60% by mass of one or more waste compounds included in the waste material 202, at least about 70% by mass of one or more waste compounds included in the waste material 202., or at least about 80% by mass of one or more waste compounds included in the waste material 202. In various illustrative examples, the waste form 218 can include from about 0.5% by mass to about 80% by mass of one or more waste compounds included in the waste material 202, from about 10% by mass to about 60% by mass of one or more waste compounds included in the waste material 202, from about 20% by mass to about 40% by mass of one or more waste compounds included in the waste material 202, or from about 30% by mass to about 50% by mass of one or more waste compounds included in the waste material 202.

In one or more further illustrative examples, when the waste material 202 includes a waste component comprising radioactive iodine and a sorbent material comprising at least one of silver mordenite (AgZ) and/or silver functionalized silica aerogel (Ag⁰-aerogel), the waste form 218 can include AgI encapsulated in the one or more polymeric materials 204.

In at least some examples, the waste form 218 can be in the form of pellets or discs. In these scenarios, the waste form 218 can have diameters from about 2 mm to about 20 mm, from 5 mm to about 15 mm, from about 8 mm to about 12 mm, from about 5 mm to about 10 mm, or from about 10 mm to about 15 mm. Additionally, the waste form 218 can comprise at least one of pellets or discs having heights from about 0.2 mm to about 5 mm, from about 1 mm to about 3 mm, or from about 2 mm to about 4 mm. In various examples, the apparatus 212 can include a die that is used to form pellets or discs from the waste material 202 and the one or more polymeric materials 204. In various additional examples, the waste form 218 can have a size and/or shape that corresponds to the size and/or shape of a container or disposal environment storing the waste form 218.

Additionally, the waste form 218 can be stored in a container 220. In one or more examples, the waste form 218 can have a shape that corresponds to the shape of the container 220. In various examples, the container 220 can be comprised of one or more metallic materials. In scenarios where the waste form 218 includes one or more radioactive materials, the container 220 can be comprised of one or more metals that can capture any radioactive material released from the waste form 218. In one or more additional examples, the container 220 can be comprised of materials that will withstand decay over long periods of time.

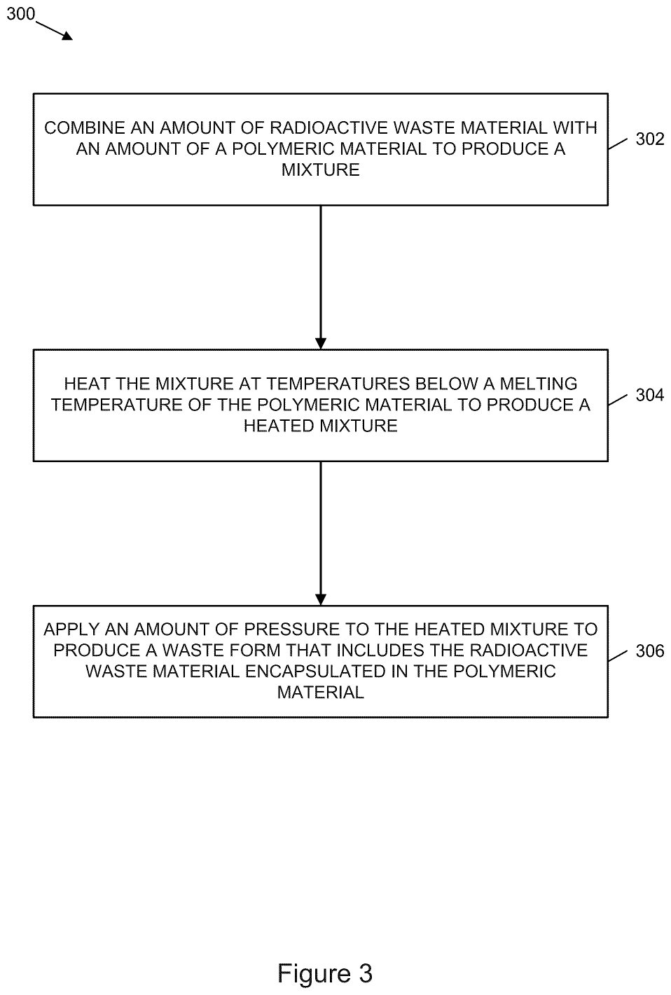

FIG. 3 illustrates a flow diagram of a process 300 to capture and store waste material produced in conjunction with one or more industrial processes, in accordance with one or more examples. The process 300 can include, at 302, combining an amount of radioactive waste material with an amount of a polymeric materials to produce a mixture. In one or more examples, the mixture can include from about 5% by volume to about 75% by volume of the amount of radioactive waste material, from about 20% by volume to about 40% c by volume of the amount of the polymeric material, or from about 40% by volume to about 60% by volume of the amount of the polymeric material.

In one or more additional examples, the radioactive waste material can include sorbent material loaded with one or more radioisotopes. For example, the radioactive waste materials can include sorbent material loaded with radioactive iodine. The radioactive iodine can include at least one of ¹²⁹I or ¹³¹I. In various examples, the sorbent material can include at least one of metal-exchanged zeolite sorbents, Ag-loaded aerogels, or Ag-loaded xerogels. To illustrate, the sorbent material can include at least one of silver mordenite or silver functionalized silica aerogel. In one or more additional examples, the polymeric material can include at least one of polyethylene terephthalate, polyethylene terephthalate glycol, polyether ether ketone, polycarbonate, polysulfonate, polyether sulfonate, polyethelenimine, bisphenol A-based epoxies, polydiallyl phthalate, or polyacrylonitrile. In at least some examples, the amount of radioactive waste materials can include particles that include sorbent material loaded with one or more radioisotopes and the particles have dimensions from about 500 micrometers to about 5 millimeters. In situations where the waste material is subject to grinding, the amount of radioactive waste material can include particles from about 500 micrometers to about 200 micrometers.

In addition, at 304, the process 300 can include heating the mixture at temperatures below a melting temperature of the polymeric material and above the glass transition temperature of the polymeric material to produce a heated mixture. In some cases, the mixture can be heated to temperatures less than the glass transition temperature, such as when pressure is applied to produce the mixture. In at least some examples, the mixture can be heated to temperatures at least about 50° C. below the glass transition temperature of the polymeric material. In various examples, the mixture can be heated to temperatures that are below a melting temperature and decomposition temperature of the radioactive waste material. In one or more illustrative examples, the mixture can be heated at temperatures from about 100° C. to about 300° C. to produce the heated mixture.

Further, the process 300 can include, at 306, applying an amount of pressure to the heated mixture to produce a waste form that includes the radioactive waste material encapsulated in the polymeric material. In one or more examples, the amount of pressure applied to the heated mixture to produce the waste form can be from about 0 megapascals (MPa) to about 100 MPa. In addition, the amount of pressure can be applied to the heated mixture using a uniaxial pressing process, an extrusion process, or an injection molding process. Further, the amount of pressure can be applied to the heated mixture for about 1 minute to about 60 minutes to produce the waste form. Times on the higher end of the range can be used when processing at temperatures less than the glass transition temperature of the polymeric material is used. In at least some examples, preprocessing of the mixture can be performed before applying the amount of pressure to the heated mixture. The preprocessing can include applying, to the mixture, an additional amount of pressure from about 0 MPa to about 10 MPa at temperatures from about 25° C. to about 450° C. Temperatures on the higher end of the range can be used when high temperature extrusion is used to produce the waste form.

In various examples, the waste form can include a first component including a first amount of radioactive waste material and a second component including a second amount of a polymeric material encapsulating the radioactive waste material. Additionally, the waste form can have an amount of open porosity no greater than about 1% by volume for a total volume of the waste form. Further, the waste form can have a density from about 0.5 g/cm³ to about 4.5 g/cm³. In still other examples, the waste form can have a diameter from about 1 cm to about 20 cm and have a height from about 1 cm to about 10 cm.

In scenarios where the radioactive waste material includes sorbent material loaded with one or more radioisotopes of iodine, an amount of the one or more radioisotopes included in the waste form is from about 5% by weight to about 45% by weight of a total weight of the waste form. In one or more illustrative examples, the sorbent material can include at least one of silver mordenite or silver functionalized silica aerogel. In various examples, the waste form can include AgI encapsulated in the polymeric material. In one or more additional illustrative examples, the polymeric material can include polyacrylonitrile.

### Experimental Example

### 1.0 Introduction

The goal of this project was to produce silica-based iodine waste forms from silver-functionalized silica aerogel (Ag⁰-aerogel), determine the average iodine loadings and level of densification, and ship selected samples to Argonne National Laboratory for chemical durability testing. Samples were consolidated with spark plasma sintering (SPS) or with a low-temperature encapsulation process, which was developed to address a need for an easily employed production of durable waste forms.

### 2.0 Experimental Methods

### 2.1 Production of Ag⁰-Aerogel

The Age-aerogel samples were synthesized using a three-step process (Matyáš et al. 2011 and Matyáš et al. 2018): 1) functionalization of pore surfaces of commercial silica aerogel granules with a propylthiol monolayer, 2) installation of Ag+ on the thiol monolayer interface by treatment with AgNO₃ solution, and 3) reduction of Ag+ under flowing 2.7% H₂ in Ar to produce Ag0 nanoparticles. The resulting Ag0-aerogel product is in the form of granules bigger than 0.85 mm with an average specific surface area of ˜150 m2/g, pore volume of ˜0.5 mL/g, and bulk density of ˜500 kg/m3.

Granules of silica aerogel were heated from room temperature to 725° C. at a rate of 10° C./min to remove trimethylsilyl groups installed by the manufacturer to make the aerogel hydrophobic, and then hydrated in humidity-saturated air for 25.3 h. Following hydration, 3-(mercaptopropyl)trimethoxysilane [HS(CH₂)₃Si(OCH₃)₃, 95%] (Sigma Aldrich, St. Louis, MO) was distributed throughout the granules using a syringe at −2 mL per g of unhydrated sample. The wetted material was loaded into a 1 L high-pressure vessel that was then heated to 150° C., the vessel was filled with supercritical CO₂ at 24 MPa, and the sample remained in the vessel for ˜9 days. Following this process, the thiol-modified aerogel (˜25 g) was altered by installing the Ag+ ions through treatment with 720 mL of 3.94 mass % AgNO₃ (≥99% Sigma Aldrich) solution. About 60 mL of methanol (CH₃OH) was added to the solution to facilitate wetting of the moderately hydrophobic thiol-modified aerogel. The silver nanoparticles were produced on the silica aerogel pore surfaces by reducing the silver thiolate adduct ions at 140° C. for 29 h under a 12 mL/min of 2.7% H₂ in Ar in a glass column.

Brunauer-Emmett-Teller (BET) characterization of the thiol-modified aerogel revealed a specific surface area (S) of 233 m²/g, pore volume (V) of 1.56×10-6 m³/g, and adsorption/desorption (ads/des) pore size of 33/24 nm, respectively. A highly efficient thiolation enabled the installation of a high number of silver nanoparticles on pore surfaces as indicated by BET analysis. The Ag⁰-aerogel exhibited S=132 m²/g, V=0.33×10-6 m³/g, ads/des=15/11 nm, respectively.

### 2.2 Iodine Loading of Ag⁰-Aerogel

Static sorption testing was utilized to load Ag⁰-aerogel with iodine. For each sample, approximately 6.2 g of Ag⁰-aerogel was enclosed with 2.1 or 3.1 g of solid iodine in a 1 L sealed Teflon vessel at 150° C. for 24 h. Loosely bonded or excess iodine was removed from the samples by a 48-h room temperature vacuum treatment (10 kPa in-house vacuum) in a desiccator. Subsequently, the samples were collected and weighed on an analytical balance of 0.1 mg sensitivity to obtain iodine loadings from 321 to 435 mg/g. These will increase to 352 and 492 mg/g if organic moiety is first removed from the samples.

### 2.3 Consolidation Methods

Spark plasma sintering and low-temperature encapsulation methods were used to produce waste forms for chemical durability testing at ANL.

### 2.3.1 Spark Plasma Sintering

Eight samples of Ag-aerogel with or without iodine, organic moiety, and silica were ground for 30 s in a tungsten carbide mill and consolidated with SPS at California Nanotechnologies Inc. (Cerritos, California). The SPS was performed in a 20 mm diameter die set made of high-strength graphite. For each sample, approximately 3 g of powder was heated as fast as possible from room temperature to 1200° C. with a 30 min hold under argon and 70 MPa of pressure. Then, the SPS was turned off, samples were quenched, and mailed back to PNNL for analysis. Temperature history for samples is shown in the Table 1. Table 2 lists sample IDs, description, and iodine loadings.

TABLE 1
Temperature history.

| Temperature Range, ° C. | Ramp rate, ° C./min | Time, min |
|---|---|---|
| 25-500 | ~158 | ~3 |
| 500-1100 | 300 | 2 |
| 1100-1200 | 100 | 1 |
| 1200 | — | 30 |

TABLE 2
List of SPS samples including the sample identifications,
the description, and the iodine loadings.

| | | Iodine |
|---|---|---|
| | | loading, |
| Sample ID | Description | mass % |
| 1_WF—Ag⁰-aerogel | Ag⁰-aerogel w/organic | — |
| 2_1_WF—Ag⁰-acrogel duplicate | | |
| 3_WF—I—Ag⁰-aerogel | Iodine-loaded Ag⁰-aerogel | 33.4 |
| 4_1_WF—I—Ag⁰-aerogel | w/organic | (36.4)^{a} |
| duplicate | | |
| 5_WF—I—(Si)—Ag⁰-aerogel | Iodine-loaded Ag⁰-aerogel | 30.1 |
| 6_1_WF—I—(Si)—Ag⁰-aerogel | w/organic + 10 mass % | (32.9)^{a} |
| duplicate | silica aerogel | |
| 7_WF—I—(NO)—Ag⁰-aerogel | Iodine-loaded Ag⁰-aerogel | 36.2 |
| | w/o organic | |
| 8_WF—I—(NO)—Ag⁰-aerogel | Iodine-loaded Ag⁰-aerogel | 32.6 |
| duplicate | w/o organic + 10% silica | |
| | aerogel | |

^{a}Iodine loading after removal of organic moiety.

### 2.3.2 Low-Temperature Encapsulation

Two samples, each in duplicate, were produced by encapsulation of Ag⁰-aerogel with iodine (iodine loading 435 mg/g) or Ag⁰-aerogel without iodine in a durable matrix. Approximately 0.8 g of a mixture containing 25 vol % of Ag⁰-aerogel with or without iodine and 75 vol % of a durable matrix was mixed for 30 s in a tungsten carbide mill and prepressed at room temperature in a 10-mm stainless steel die at 2,000 pounds. Then, the die was heated to target temperature (below 350° C.) while applying uniaxial pressure of 47 MPa. Table 2 lists all the samples, including their identification, description, and iodine loadings.

TABLE 3
The produced low-temperature encapsulated samples including the
sample identifications, the description, and the iodine loadings.

| | | Iodine |
|---|---|---|
| Sample ID | Description | loading mass % |
| LTE-1 | Matrix/Ag⁰-aerogel = | N/A |
| LTE-1 duplicate | 75/25 vol % | |
| LTE-2 | Matrix/I—Ag⁰-aerogel = | 15.5 |
| LTE-2 duplicate | 75/25 vol % | |

### 2.4 Experimental Analysis

The consolidated samples were analyzed with Archimedes method for bulk density and open porosity and with scanning electron microscopy and energy dispersive spectroscopy (SEM/EDS) for the extent of densification, macro- and microstructural changes, distribution of individual elements, and to estimate iodine loadings.

### 2.4.1 Archimedes Method

The samples were weighed on an analytical balance (Sartorius model A200S, Brinkmann Instruments Co., Westbury, New York) to an accuracy of 0.1 mg (m_{dry}) before being suspended in ethanol (EtOH) for 2 h under in-house vacuum (10 kPa) to allow the EtOH to penetrate any open and surface-connected porosity. The samples were then weighed both suspended in EtOH (mₛᵤₛ) and in air saturated with EtOH (mₛₐₜ). The bulk densities of the samples were calculated according to Eq. (1):

$${ρ}_{sample} = \frac{( {m}_{dry} {ρ}_{EtOH} )}{( {m}_{sat} - {m}_{sus} )} \qquad ( 1 )$$

where mᵢ is the mass in the i-th configuration (i=dry, saturated, and suspended, respectively), and ρ_{EtOH} is the density of EtOH at the temperature of the test (0.7886×103 kg/m3 at 21° C., ASTM C693-93). The open porosity of the samples was calculated according to Eq. (2).

$$\% OpenPorosity = \frac{( {m}_{sat} - {m}_{dry} )}{( {m}_{sat} - {m}_{sus} )} \times 100 \qquad ( 2 )$$

A sample of aluminum with a density 2.700×103 kg/m³ and zero open porosity was run with the samples to validate the obtained densities and open porosities. The measured density 2.698×103 kg/m³ and open porosity 0.2% were in good agreement with values for aluminum metal.

### 2.4.2 Scanning Electron Microscopy and Energy Dispersive Spectroscopy

A JEOL JSM-7001F/TTLS scanning electron microscope equipped with a field emission gun was used to examine consolidated samples in a low vacuum mode at an accelerating voltage of 15 kV to minimize beam penetration. The EDS analyses were performed using a Bruker xFlash 6|60 (Bruker AXS Inc., Madison, WI).

### 3.0 Results and Discussion

### 3.1 Optical Images

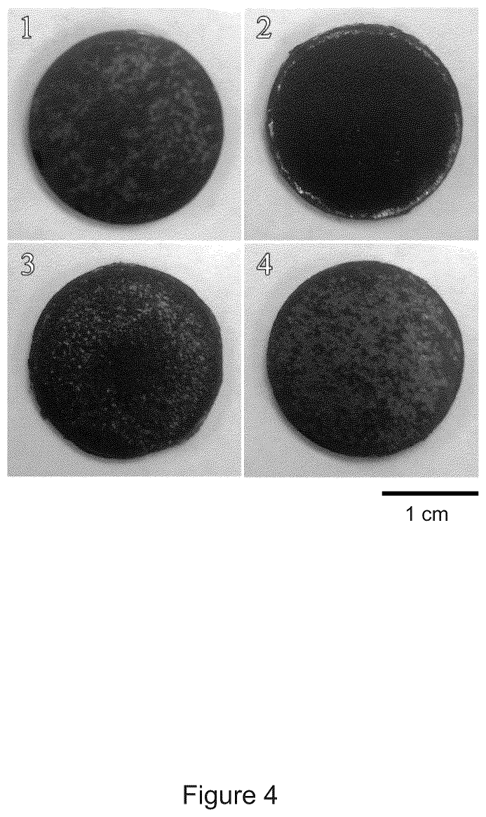

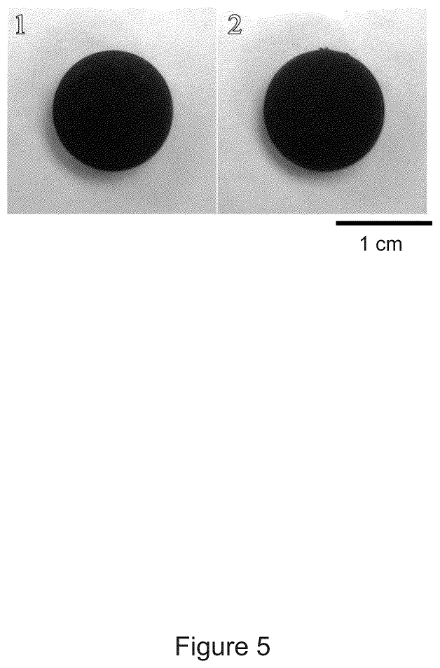

Pictures of the samples produced with SPS and low-temperature encapsulation methods are shown in FIG. 4 and FIG. 5. Samples were black in color and had a surface contaminated by flakes of residual graphite from graphite spacer sheets (bright glittering areas).

### 3.2 Density and Open Porosity Data

Table 4 provides bulk densities and open porosities for selected samples. Bulk densities ranged from 1.4 to 3.2 g/cm³. Only a small amount of open porosity (up to 3.1%) was observed in the samples confirming efficiency of SPS and low-temperature consolidation methods to generate dense products.

TABLE 4
Summary of measured densities (ρ_{b}) and
open porosities (OP) for selected samples.

| | | ρ_{b} | OP |
|---|---|---|---|
| Sample ID | Consolidation Method | (g/cm³) | (%) |
| 1_WF—I—Ag⁰-aerogel | SPS | 3.188 | 0.2 |
| 3_WF—I—Ag⁰-aerogel | SPS | 2.180 | 3.1 |
| 5_WF—(Si)—Ag⁰-aerogel | SPS | 2.200 | 1.0 |
| LTE-1 | Low-temperature | 1.363 | 0.3 |
| | encapsulation | | |
| LTE-2 | Low-temperature | 1.578 | 0.4 |
| | encapsulation | | |

### 3.3 SEM-EDS Analysis

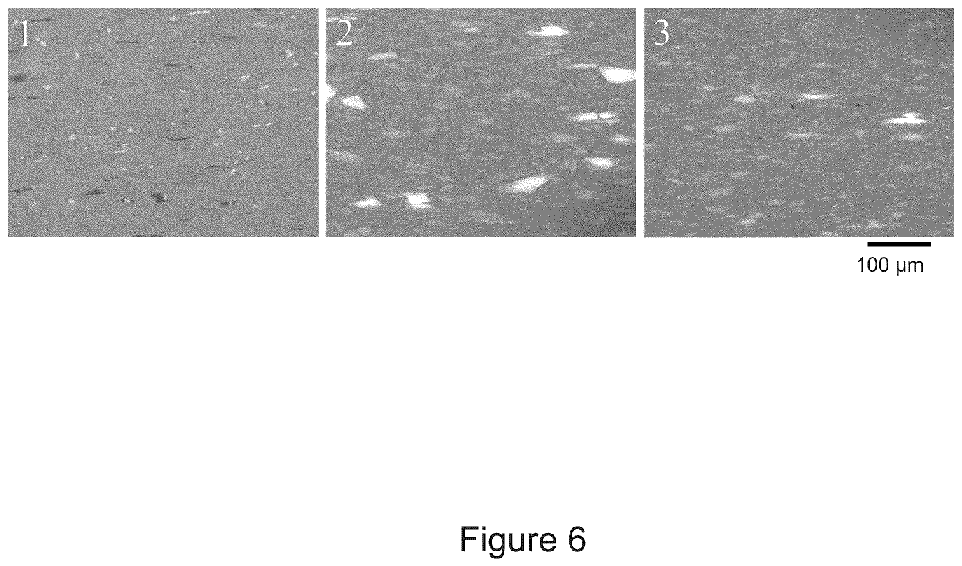

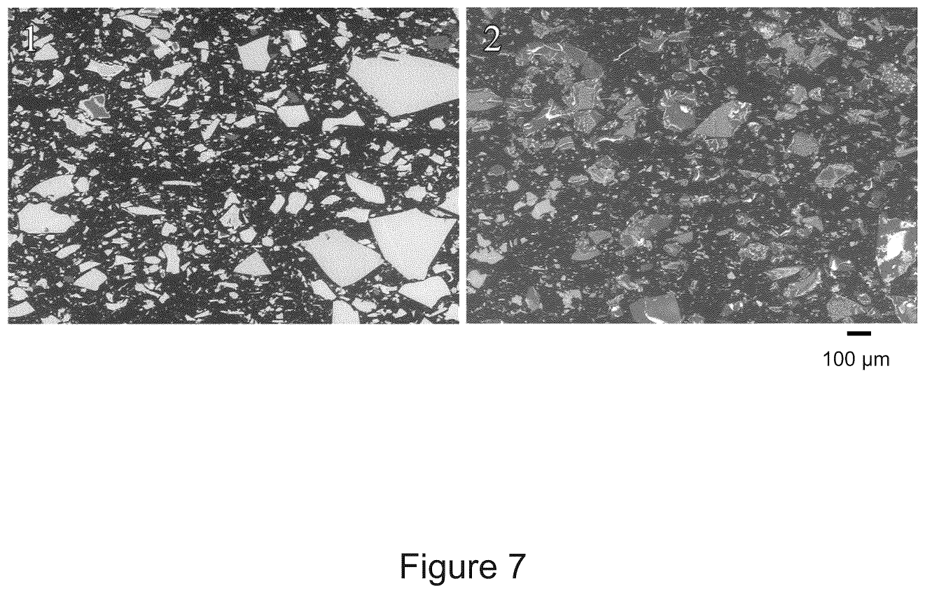

Selected SEM micrographs of samples consolidated with SPS and low-temperature encapsulation methods are provided in FIG. 6 and FIG. 7. The EDS data are summarized in Table 5 that include values collected from different locations of the samples.

TABLE 5
Summary of normalized EDS-measured compositions
in mass % for selected samples consolidated with
SPS and low-temperature encapsulation methods.

| Sample ID | O | Si | Si | Ag | I |
|---|---|---|---|---|---|
| 3_WF—I—Ag⁰-aerogel | 25.9 | 22.0 | 0.4 | 28.1 | 23.6 |
| 5_WF—(Si)—Ag⁰-aerogel | 41.2 | 43.6 | 0.5 | 7.6 | 7.1 |
| LTE-2 | 23.0 | 31.1 | 6.9 | 22.0 | 19.1 |

### 4.0 Summary and Conclusions

The samples produced with SPS contained only small amount of open porosity (≤3.1%). The iodine-loaded samples contained high concentrations of iodine, which was retained in the form of nano- and microparticles of AgI. These particles were dispersed inside the silica grains but also accumulated along the grain boundaries. The results of previous investigations (Matyáš et al. 2018) showed that AgI is present in the form of two crystalline modifications: 1) β AgI with a wurtzite structure and 2) γ AgI with a zincblende structure.

A low-temperature consolidation method was developed to consolidate iodine-loaded Ag⁰-aerogel. Fully densified product was obtained for “Matrix/iodine-loaded Ag⁰-aerogel” fraction 75/25 vol % with iodine loading ˜16 mass %. This concentration of iodine agreed well with the results from EDS analysis. The invention disclosure record has been drafted for this method, which included a suit of low-temperature matrices selected for their potential to be used as durable waste forms. The next step would be to further develop this method based on the feedback from chemical durability testing.

What is claimed is:

1. A method comprising:
combining an amount of radioactive waste material with an amount of a polymeric material to produce a mixture;
heating the mixture at temperatures above a glass transition temperature of the polymeric material and below a melting temperature of the polymeric material to produce a heated mixture; and
applying an amount of pressure to the heated mixture to produce a waste form that includes the radioactive waste material encapsulated in the polymeric material.

2. The method of claim 1, wherein the radioactive waste material includes sorbent material loaded with one or more radioisotopes.

3. The method of claim 1, wherein the radioactive waste material includes sorbent material loaded with radioactive iodine.

4. The method of claim 2, wherein the sorbent material includes at least one of metal-exchanged zeolite sorbents, Ag-loaded aerogels, or Ag-loaded xerogels.

5. The method of claim 4, wherein the sorbent material includes at least one of silver mordenite or silver functionalized silica aerogel.

6. The method of claim 1, wherein the polymeric material includes at least one of polyethylene terephthalate, polyethylene terephthalate glycol, polysulfonate, polyether sulfonate, polyethylenimine, polyether ether ketone, polycarbonate, polydiallyl phthalate, or polyacrylonitrile.

7. The method of claim 1, wherein the mixture is heated at temperatures from about 80° C. to about 500° C. to produce the heated mixture.

8. The method of claim 1, wherein the amount of pressure applied to the heated mixture to produce the waste form is from about 0 megapascals (MPa) to about 100 MPa.

9. The method of claim 1, wherein the amount of pressure is applied to the heated mixture using a uniaxial or isostatic pressing process, an extrusion process, or an injection or compression molding processes.

10. The method of claim 1, wherein the mixture includes from about 5% by volume to about 75% by volume of the amount of radioactive waste material and from about 25% by volume to about 95% by volume of the amount of the polymeric material.

11. The method of claim 1 wherein the amount of pressure is applied to the heated mixture for about 1 minute to about 60 minutes to produce the waste form.

12. The method of claim 1, wherein the amount of radioactive waste materials includes particles that include sorbent material loaded with one or more radioisotopes and the particles have dimensions from about 500 micrometers to about 5 millimeters.

13. The method of claim 1, comprising performing preprocessing of the mixture before applying the amount of pressure to the heated mixture, wherein the preprocessing includes applying, to the mixture, an additional amount of pressure from about 0 MPa to about 10 MPa at temperatures from about 15° C. to about 450° C.

14. An article comprising:
a first component including a first amount of radioactive waste material; and
a second component including a second amount of a polymeric material encapsulating the radioactive waste material;
wherein the article has an amount of open porosity no greater than about 1% by volume for a total volume of the article.

15. The article of claim 14, wherein:
the radioactive waste material includes sorbent material loaded with one or more radioisotopes of iodine; and
an amount of the one or more radioisotopes included in the article is from about 5% by weight to about 45% by weight of a total weight of the article.

16. The article of claim 14, having a density from about 0.5 g/cm³ to about 4.5 g/cm³.

17. The article of claim 15, wherein the sorbent material includes at least one of metal-exchanged zeolite sorbents, Ag-loaded aerogels, or Ag-loaded xerogels.

18. The article of claim 14, wherein the polymeric material includes at least one of polyethylene terephthalate, polyethylene terephthalate glycol, polyether ether ketone, polysulfonate, polyether sulfonate, polyethyleneimine, polycarbonate, polydiallyl phthalate, or polyacrylonitrile.

19. The article of claim 14, having a diameter from about 1 cm to about 20 cm and having a height from about 1 cm to about 10 cm.

20. The article of claim 14, wherein:
the radioactive waste material includes sorbent material loaded with one or more radioisotopes of iodine;
the sorbent material includes at least one of silver mordenite or silver functionalized silica aerogel:
an amount of the one or more radioisotopes included in the article is from about 10% by weight to about 25% by weight of a total weight of the article; and
the polymeric material includes polyacrylonitrile.
